(19) United States
(12) Patent Application Publication
(10) Pub. No.: US 2004/0083287 A1
(43) Pub. Date: Apr. 29, 2004

(54) Terminal-based resource reservation protocol

(76) Inventors: Xia Gao, Campbell, CA (US); Gang Wu, Cupertino, CA (US)

Correspondence Address: INDIANAPOLIS OFFICE 27879, BRINKS HOFER GILSON & LIONE, ONE INDIANA SQUARE, SUITE 1600, INDIANAPOLIS, IN, 46204-2033, US

(21) Appl. No.: 10/280,986

(22) Filed: Oct. 25, 2002

(51) Int. Cl. G06F 15/173; G06F 15/16

(52) U.S. Cl. 709/226; 709/232

(57) ABSTRACT

A packet-switched data network is disclosed that includes a dynamic resource reservation adjustment module that adjusts unicast data flows in reserved resources of the data network to maintain an optimal level of QoS for an application session. A receiver node obtains a reservation for a plurality of unicast packet flows from various routers on the data network. The receiver node also makes a partial reservation for a predetermined amount of bandwidth on each respective router to compensate for one of the unicast packet flows if a respective router experiences a bottleneck.

### FIELD OF THE INVENTION

The present invention relates generally to resource reservation in data networks and more particularly, to a dynamic resource reservation protocol for use by receiver terminals having multiple data flows.

### BACKGROUND OF THE INVENTION

Recent years have witnessed an explosive growth of mobile computing as well as the speedy emergence of various new wireless technologies. The desire to be connected any time, any where, and any way leads to an increasing array of heterogeneous systems, applications, devices and operators. It is envisioned that such heterogeneity is unlikely to disappear in the foreseeable future because the variety of the application requirements makes it difficult to find an optimal and universal solution, and the eagerness to capture the market makes competing organizations to release non-interoperable systems. As a result, the ability to provide seamless services in such heterogeneous environment is the key to the success of the next generation of mobile communication systems.

To enable seamless experience, location based services, service discovery and service composition techniques are gaining prime importance. While these new techniques have the potential to provide users with more functionalities and conveniences, one big problem that has to be solved to make these services fully take off is to guarantee the Quality of Service (QoS) during the application lifetime. One paradigm of QoS support is integrated service (Inte-Serv), which is connection-oriented and depends on setting up the QoS path before the data transmission. But traditional Inte-Serv protocols such as resource reservation protocol (“RSVP”) exhibit numerous problems in such ubiquitous mobile environments and require extensive modification to meet QoS requirements of the new application services.

RSVP is the current standard for supporting Inte-Serv in IP network. It is well understood that in order to provide guaranteed service some kind of reservation or admission control is needed at the edge router no matter what kind of QoS mechanism is used in the core network. RSVP or its extension is the popular signaling protocol used by a host to request specific QoS from the network for particular application data streams. It is also used by the routers to deliver QoS requests to all nodes along the path of the streams and to establish and maintain the requested services. It works closely with other components in the Inte-Serv framework including flow specification, routing, admission control, policy control and packet scheduling. RSVP supports both unicast and multicast data flows. It is a receiver-initiated reservation protocol to facilitate the accommodation of heterogeneous receivers and changes of multicast group membership. It provides different reservation styles to improve the usage of the bandwidth and allow the multiplexing of different senders in the same multicast group. It uses “soft state” in intermediate routers that automatically expires after some time interval to deal gracefully with route changes or failures.

Another set of protocols includes MRSVP, RSVP-A and other modifications to the RSVP signaling protocol. Because RSVP is designed without the consideration of mobility by its receiver-initiating algorithm, MRSVP and its relatives are proposed to support mobility. They are based on proactively setting up a resource reservation in other base stations where the application is likely to travel. Besides receiver-based reservation protocols, sender-based reservation protocols such as SRP and YESSIR are also proposed. SRP tries to solve the scalability problem of RSVP by relying on the end-system to estimate their accepted reservation and not to exceed the limit so that the intermediate routers do not need to maintain per-flow state and can provide controlled load services by measuring the resource usage. YESSIR is a light-weighted protocol that uses one-pass signaling and allows partial reservation.

There are several design issues related to reservation signaling that must be taken into consideration including scalability factors, signaling overhead, partial reservation, and reservation retry methods. Some of the factors that strongly influence signaling scalability are protocol complexity, QoS state management efficiency, and simplicity in configuration. Generally, there is a tradeoff between end-user flexibility and the signaling message process overhead. RSVP is a two-pass protocol in which a path message from the sender and a reservation message from the receiver are needed to complete the reservation process. YESSIR is a one-pass protocol, which only needs the sender to send out the flow specification message to each receiver to make the reservation.

In RSVP if a reservation request is denied, the request message is dropped at the router and “blockade states” are produced to limit the retries for the reservation during the next refresh cycle. On the other hand, some protocols such as YESSIR allow partial reservation that try to make reservations on as many hops or routers as possible so that the failed reservation request is still forward downstream. Because partial reservations do not provide the QoS that end users have originally requested, how to make the reservation in the missing link or recover from the reservation fail state is an important issue.

Despite their different choices of these design issues, existing signaling protocols share one common characteristic that the reservation is based on a single flow identified by five-tuple (source and destination address, source and destination port, and protocol type). For most of the traditional Internet applications such as FTP or Email, only one communication flow exists between a server and a client. For more complicated applications such as video-conferencing, even if several communication flows are opened at the same time to transmit video, audio or text information, they can be treated as one single flow in some way by reservation protocols because all the flows share the same connection peers and network links accordingly. In all these application scenarios, flow-based reservation protocols work fine.

Different from above single flow-based scenario, there exist applications that have multiple data flows communicating with peers that are located in completely different networks and differ dramatically in terms of computation and communication ability. To have more insight of such a scenario, an on-line gaming scenario will briefly be discussed below.

In a typical on-line game setting, people log on to game servers to play an interactive game with other players. Sometimes teams comprising of several players are formed to compete with other teams. To play efficiently, each player needs to communicate well with other team members. Hence, good communication channels are necessary. An audio channel may be useful for players to ask for help, synchronize activities, or exchange commands. A video channel may be useful for players to get snapshots of other players, to share maps, or to have quick idea of what is happening there. It can be imagined that by adding more communication channels, more functionalities can be integrated into gaming applications.

Compared with the scenarios set forth above where multiple data flows share the same source and destinations, the application here may have multiple data flows that have different communication peers and network links. Reservations have to be handled independently, but their performance has to be coordinated to achieve better overall application performance.

In more complicated scenarios where new techniques such as location based services, service discovery and service compositions are used to dynamically search, compose and present services, the application flows may dynamically change configuration or communication peers. Furthermore, because of the channel limitation ability of wireless channel and processing capability of mobile terminal, different applications running on the same terminal also compete with each other to receive limited services from the network and the terminal.

In all these more advanced application scenarios, traditional resource reservation protocols no longer fit. Some of the most relevant influences are briefly discussed below. When these applications are selected simultaneously by the user to finish one or several tasks, one common problem is how to schedule the task to achieve the best user perceived performance. One example is how to schedule the task finish time that is handled by a traditional operating system scheduler. The other facet of the problem is how to adjust communication resource usage of each application or each flow of one application when communication bottleneck is prominent.

Resource reservation protocol operates in the network layer so that the basic granularity of reservation is flow, which is usually addressed by five-tuple. In the application layer, the basic granularity is one application task. While many early Internet applications such as FTP or email utilize only one network flow to communicate, today's multimedia intensive and communication intensive applications can involve multiple flows in order to finish one task. Especially when a service composition technique is used to provide a user with a comprehensive service by dynamically integrating together a large amount of simple and diversified services, one application session could include data flows originating from different addresses.

Among the applications running on the same terminal, the relative importance of each application could vary according to a current user preference. How to dynamically adjust the communication resource among these applications in this scenario is an open question. Further, when one application involves multiple flows, the support of dynamic configuration is a must.

Traditional reservation signaling protocols need to be carefully modified to allow efficient and flexible reservation. Besides their own intrinsic problems, below is a description of the common problems these schemes have so that one may gain a better understanding of the present invention. To make things clear, an application session is defined as one application that has one or multiple communication flows. A terminal session is defined herein as the composition of multiple application sessions that run on one specific terminal and compete with each other to get communication resources. Generally speaking, an application session is a subset of a terminal session so that the terminal session sometimes is abbreviated to just session.

As generally set forth above, current reservation protocols are based on network flow level. The performance of one application depends on the overall performance of all the flows of the same session. So, if some of the flows of the session receive good treatment while other flows experience congestion, the application performance can deteriorate greatly. If several application sessions of the same terminal session all have multiple flows, their flows form a bigger set.

Current reservation protocols also have no cooperation among reservations of multiple flows of the same session. Because current reservation is flow based, each flow is treated independently. Once the reservation of one flow fails, the current method is to either to retry later or to make a smaller request.

RSVP or its extensions assume that multiple senders and multiple receivers share the same multicast address so that the reservation can be uniquely addressed and shared among different senders, and the request from different receivers can be merged at the intermediate routers. Application session here involves multiple flows subscribing to multiple senders, which have no connection with each other. Hence, the multicast tree is not easy to form and the existing protocols cannot be migrated to this scenario directly.

Current protocols also have no efficient support of dynamic adjustment of the configuration of the application session. RSVP uses receiver-based reservation messages to allow the dynamic joining or departure receiver terminals. In the scenario here, one application session comprises of multiple unicast flows so that the dynamic configuration and reservation of application sessions cannot be handled by RSVP type protocol. The dynamic adjustment of flows of the same application or of the same terminal session is not studied yet.

### SUMMARY OF THE PRESENT INVENTION

One embodiment of the present invention discloses a network system. The network system includes a receiver terminal that is connected with a sender terminal by a plurality of hops or routers. The receiver terminal includes a resource reservation processing module that is operable to create a plurality of unicast packet flow reservations on the hops during an application session between the receiver terminal and the sender terminal. The receiver terminal also includes a partial resource reservation processing module that is operable to create and maintain a partial reservation on the hops. Further, the receiver terminal includes a dynamic adjustment module having a dynamic adjustment algorithm operable to provide a less optimal reservation to compensate for a bottleneck experienced in a respective hop.

Yet another embodiment of the present invention discloses a method of adjusting data flows in a data network. This embodiment includes the steps of reserving resources for a plurality of packet flows on a plurality of routers connected with a receiver terminal; sending a feedback message from the routers to the receiver terminal indicating a bottleneck in a respective data flow; determining an optimal packet flow reservation distribution based on a predetermined criteria with the receiver terminal; and generating a resource reservation update message that is transmitted to the respective router with the bottleneck adjusting the packet flows at the respective router to compensate for the bottleneck.

As described above in the background section, current schemes supporting resource reservation at the routers do not solve the session based reservation problem because of their lack of knowledge of a new breed of application services that require multiple data flows with different levels of QoS from the same application session. The present invention adapts the existing reservation frameworks to solve this application session based reservation problem.

The terminal-based resource reservation protocol provides terminal and application session based resource reservation. The present invention achieves optimal application performance and user perceived performance by integrating the reservation of multiple data flows originating from the same application session or multiple application sessions on the same terminal if necessary. This contrasts with traditional resource reservation protocols that treat each flow independently so that the overall terminal (or application) session performance cannot be guaranteed.

The preferred embodiment of the present invention provides an interface between dynamic reservation modules and signaling protocol suitable for the interaction among these multiple data flows. After discussing a generic dynamic reservation adjustment algorithm, the new interface is decided which includes the location and flow composition of bottlenecks of competing flows in the same terminal or application session.

The present invention enables the end-host to learn the common bottleneck of multiple flows of the same session and allows the end host to dynamically adjust resources among these flows based on specific application criteria to achieve the optimal performance.

Further objects and advantages of the present invention will be apparent from the following description, reference being made to the accompanying drawings wherein preferred embodiments of the invention are clearly illustrated.

### BRIEF DESCRIPTION OF THE DRAWINGS

FIG. 1 illustrates one embodiment of a core data network.

FIG. 2 illustrates application modules of the receiver terminal and routers.

FIG. 3 is a flow chart illustrating the process steps performed by the receiver terminal.

FIG. 4 is a flow chart illustrating the process steps performed by the routers along the data path.

### DETAILED DESCRIPTION OF THE PRESENT PREFERRED EMBODIMENTS OF THE INVENTION

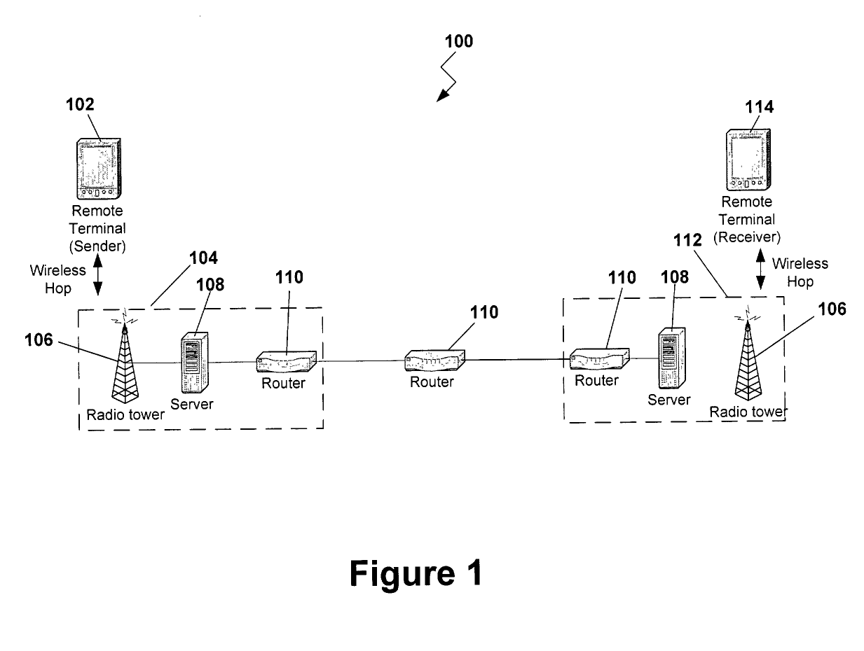

Referring to FIG. 1, an embodiment of the present invention discloses a terminal-based resource reservation protocol for use in a data network 100. The data network 100 includes a sender terminal or host 102 that is connected with a first access network 104. The first access network 104 illustrated in FIG. 1 is a wireless access network that includes a base station 106 that is connected to an access network server 108. The access network server 108 is connected with at least one router 110. The routers 110 are connected with a second access network 112 that generally includes the same components and applications of the first access network 104. The second access network 112 is connected to a receiver terminal 114.

The data network 100 illustrated in FIG. 1 is set forth as a wireless data network for illustrative purposes only. The data network 100 may be a wired data network in other embodiments of the present invention. The first and second access networks 104, 112 could be wired networks or wireless networks. In addition, the sender remote terminal 102 and the receiver remote terminal 114 may either be wireless hosts or fixed hosts. The illustration of a wireless access network in FIG. 1 should not be construed as a limitation of the present invention unless specifically set forth in the claims that follow.

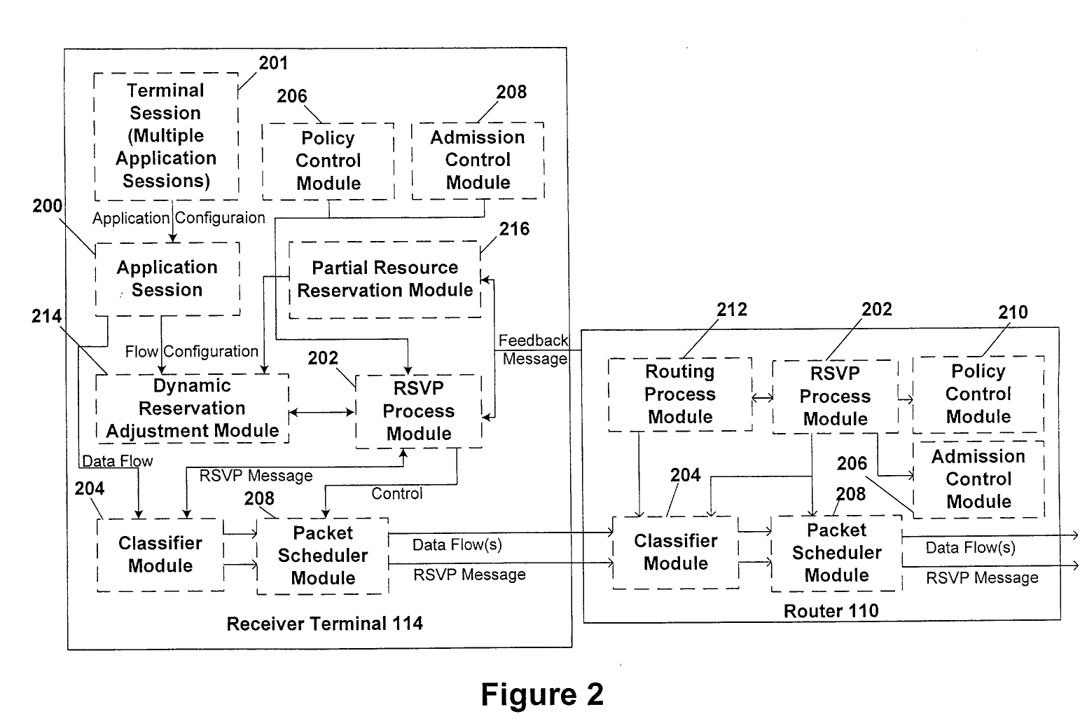

Referring collectively to FIGS. 1 and 2, the terminal-based resource reservation protocol is used by the receiver terminal 114 to request specific QoS for multiple data flows from an application session 200 or a terminal session 201 running on the receiver terminal 114. It is used by the routers 110 to deliver reservation request messages to all nodes or routers 110 along the path of data flow and to establish and maintain states to provide the requested level of QoS. The terminal-based resource reservation protocol requests resources from the routers 110 for simplex data flows in that it requests resources in only one direction. The sender terminal 104 is logically distinct from the receiver terminal 114 and one receiver terminal 114 may have connections with multiple sender terminal 104s at the same time.

A reservation request message for the session 201 is generated by the receiver terminal 114 is passed to a resource reservation protocol process module 202 on the routers 110 along the data path. The resource reservation protocol process module 202 is used to generate the reservation request message. A protocol message then carries the reservation request message to all of the routers 110 along the reverse data path from the receiver terminal 114 to the sender terminal 102. The resource reservation protocol process module 202 on the receiver terminal 114 is responsible for generating the reservation request message and the resource reservation protocol process module 202 of the routers 110 is responsible for forwarding the reservation request message to all hops or routers 110 along the data path.

QoS is implemented for the data flows by a set of traffic control modules that are located on the receiver terminal 114 and the routers 110. The traffic control modules are responsible for setting up and maintaining the connections and QoS for the data flows. The traffic control modules generally include a packet classifier module 204, an admission control module 206, and a packet scheduler 208. Each receiver terminal 114 and router 110 preferentially includes the traffic control modules.

The packet classifier module 204 determines a QoS class for each packet. The packet classifier 204 may also be responsible for determining the route for each packet. The packet scheduler 208 achieves the promised QoS. During reservation setup, a reservation request message is passed to the admission control module 206 and a policy control module 210 on the receiver terminal 114 and the routers 110. The admission control module 206 determines whether the node has sufficient available resources to supply the requested level of QoS. The policy control module 210 determines whether the user has administrative permission to make the QoS reservation on the router 110. If both checks pass, parameters are set in the packet classifier module 204 and the packet scheduler module 208 to obtain the requested QoS. If the checks fail, an error notification is sent from the router 110 to the receiver terminal 114.

The terminal-based resource reservation protocol includes several types of messages. Each receiver terminal 114 generates and transmits a reservation request upstream toward the sender terminal 102. The reservation request messages follow the reverse path that data packets will travel to the sender terminal 102. The reservation request messages create a reservation state in each router 110 along the data path. The reservation messages are then delivered to the sender terminal 102 so that the sender terminal 102 can set up appropriate traffic control parameters for the first hop along the data path.

The reservation messages preferentially contain a flowspec object and a filter spec. A flowspec object consists of two sets of numeric parameters. The first numeric parameter is an RSPEC that defines the desired level of QoS that is being requested and the second numeric parameter is a TSPEC that describes the traffic characteristic of the data flow. The filter spec, together with a session specification, defines the set of data packets to receive the QoS defined by the flowspec. The flowspec is used to set parameters in the routers 110 packet scheduler module 208, while the filter spec is used to set parameters in the packet classifier module 204.

The reservation request message is passed to the admission control module 206 and the policy control module 208 at each hop or router 110 along the data path. If the admission control module 206 or the policy control module 208 fail to authorize the request, an error message is generated and sent to the receiver terminal 114. If both succeed, the router 110 sets the packet classifier to select the data packets defined by the filter spec and it interacts with the appropriate link layer to obtain and provide the request level of QoS defined by the flowspec. The routers 110 are also responsible for forwarding the reservation request message upstream towards the sender terminal 102.

The terminal-based reservation protocol, like RSVP, supports four basic message types. The four basic message types are reservation request messages, path messages, error and confirmation messages and teardown messages. Each sender terminal 102 generates and transmits the path message downstream along the unicast or multi-cast data route provided by a routing protocol. The path messages store a path state in each router 110 along the data path. The path state includes at least the unicast IP address of the previous hop node or router 110, which is used to route the reservation messages hop-by-hop in the reverse direction.

Every message that is sent includes a session object that identifies a data flow. The session object contains a destination IP address of the data flow, a protocol ID and a destination port number. Each data source periodically sends the path message to set up the path state at the routers 110 along the path from the sender terminal 102 to the receiver terminal 114.

Three error and confirmation messages are commonly used with resource reservation protocols. These messages include a path-error message, a reservation request error message, and reservation request confirmation messages. Path error messages result of path errors and are routed hop by hop. Reservation request error messages result from reservation request messages and travel toward the receiver terminal 114. Information carried in error messages may include an admission failure indication, a bandwidth unavailable notification, a service not supported message, and a bad flow specification. Reservation request acknowledgment messages are sent as the result of the appearance of a reservation confirmation object in a reservation request message. A teardown message removes the path and reservation state from all routers 110 downstream from the point of initiation.

In the preferred embodiment of the present invention, each terminal session 201 has one or multiple application sessions 200 whose relative importance or weight could be changed dynamically and each application session 200 in turn includes multiple elastic flows receiving traffic by unicast traffic or by subscribing to independent multicast trees. Each flow is either coded by layers or progressively coded so that different levels of reservation can be made based on current network traffic load. In addition, the receiver terminal 114 has the ability to understand the specific application performance optimization criteria and overall terminal performance criteria. When one terminal session 201 involves multiple flows and some of the flows' reservations conflict with each other in some bottleneck along the data path, the receiver terminal 114 is informed of this and is capable of adjusting each flows' reservation requirements according to its individual criteria. The signaling protocol collects information about the places of the bottlenecks and the flows sharing them and forwards this information to the receiver terminal 114.

The core data network 100 must also have the capability to support QoS. Because the end-to-end QoS is the same as the weakest link, if the core data network 100 is only best-effort service based, there is nothing that can be controlled to achieve the end-to-end QoS guarantee. The core data network 100 is equipped with a QoS ability to support the use of connection oriented resource reservation protocol such as RSVP. Although the RSVP protocol has the scalability problem, it still can be used in the edge networks where the congestions are likely to happen. Especially when considering a wireless access network, because the wireless link usually has lower bandwidth and larger loss probability so it is likely to be the bottleneck where the scalability is not the main issue.

The present invention provides an interface between the dynamic reservation module and reservation signaling protocol resided on the terminal 214. As set forth above, the integrated services framework includes several interacting modules including the packet classifier module 204, the admission control module 206, the packet scheduler module 208, and the policy control module 210. The classifier module 204 may contain a service contract that specifies the traffic that the source will send and the resources and services that data network 100 promises to commit to the data transmission. A signaling or route processing module 212 may be used to provide a protocol that is used to travel through the data path hop by hop and install the reservation state in the routers 110.

The admission control module 206 at the routers 110 makes the decision of whether or not to accept the reservation request by monitoring its source usage. The policy control module 208 is used to check whether the data flow has the authorization to make the reservation and to make other decisions based on policy issues. If a data flow fails in the policy control module or the admission control module, the reservation request will be denied by that respective router 110. The last step of resource reservation is packet scheduling, which is accomplished by the packet-scheduler module 208. Packet scheduling is responsible for enforcing resource allocation by selecting a packet to transmit when an outgoing port is ready on each respective router 110.

As we mentioned in previous section, in order to achieve session-based reservation, more information should be collected in order for the receiver terminal 114 to dynamically adjust reservation request messages among its multiple data flows. As set forth in detail below, a dynamic reservation adjustment algorithm included in a dynamic reservation adjustment algorithm module 214 located on the receiver terminal 114 is disclosed herein that is used to adjust the information contained in the reservation request messages sent to the routers 110 along the data path so that reservations are adjusted accordingly among multiple data flows.

The dynamic reservation adjustment algorithm runs on the receiver terminal 114 rather than intermediate routers 110 because only the application session 200 is able to determine the relative importance of each data flow and the overall bottleneck of peer flows. The receiver terminal 114 has the flexibility to implement different dynamic reservation adjustment algorithms based on its own criteria. Such criteria are specified in two hierarchical modules, terminal session module specifying the relative importance of different application sessions on the terminal, and application session modules specifying the relative importance of multiple flows of themselves.

The present preferred dynamic reservation adjustment algorithm is set forth below and assumes that 1) an application session S has multiple sub-flows, Si, i ∈ {1, . . . , ni};2) ∀ Si , existing layering bandwidth requirements Ri1<=Ri2. . . <=Rij, j ∈ {1, . . . , nij}; and 3) for each bottleneck Li, existing a subset SLi of S, which shares the bottleneck Li and has made a reservation of ELi. The dynamic reservation adjustment algorithm determines the distribution of Si, i ∈ {1, . . . , ni} such that the application session 200 performance function F(S1, S2, . . . , Sni) is optimized, and ΣRmj<ELi , m ∈ SLi, ∀ Li. After the problem is formalized this way, different linear programming or nonlinear programming techniques may be used to find the optimal distribution of the reservation of each peer data flow according to the choice of performance function of F(S1, S2, . . . , Sni).

Analyzing the dynamic reservation adjustment algorithm, it was determined that three additional pieces of information are necessary. These additional items consist of 1) layering information or bandwidth adaptation ability of each individual data flow (i.e., property of Rij); 2) The composition of peer flows sharing some bottleneck (i.e., SLi); and 3) an existing reservation already made in the intermediate router 110 (i.e., ELi).

Before a data service is added into one application session 200, the application session 200 has to get the information of the service from some application server which is not shown in the graph so that the information about the layering information can be acquired at the same time. So with respect to the signaling protocol, the information of Rij is considered to be acquired off-line. Hence, only the information of part 2 and 3 needs to be collected by the signaling protocol. The signaling protocol focuses on how to efficiently acquire such information and how to use it to update partial reservation state.

Referring to FIG. 2, the receiver terminal also preferentially includes a partial resource reservation module 216. The partial resource reservation module 216 is used to create and maintain a partial resource reservation on the routers 110. The partial resource reservation is for a sub-flow of packets that can be used to compensate for bottlenecks experienced by respective routers 110. The dynamic reservation adjustment algorithm module 214 gets the information from the partial resource reservation module 216 of what unicast packet flow needs to be compensated and how much compensation must take place to maintain a predetermined level of QoS.

The preferred signaling protocol is a receiver based reservation protocol and is a modification of RSVP by integrating partial reservation ability, new reservation updating ability and bottleneck feedback ability. The terminal session 201 is considered to have multiple unicast data flows, each of which uses RSVP signaling protocol to communicate with its unicast peer or join the multicast group running RSVP. The successful resource reservation behaves the same as the ordinary RSVP protocol. However, when some data flow fails, the present invention collects necessary information about the bottleneck and provides this information to the receiver terminal 114. Then, based on the dynamic reservation adjustment algorithm located on the receiver terminal 114, an optimal sub-flow reservation is calculated and existing partial and completed reservations are updated on respective routers 110. Reservation updating is carried on among resource already reserved by the application session 200 so that the updating succeeds in normal conditions.

The new signaling protocol provides a common session ID for the multiple data flows of the same terminal session 201. The common session ID may be carried either by a RSVP object in an RSVP header or an IP extension field. When the reservation is granted in the intermediate router 110, both the ordinary five-tuple (source and destination address, source and destination port, and protocol type) and the session ID is recorded. Later, when some reservation fails in the admission control, the information of all data flows traversing this router 110 and sharing the same session ID is sent back to the receiver terminal 114. In this way, the location of bottleneck, the composition of competing flows, and already reserved resources on this router 110 is learned by the receiver terminal 114.

The present invention also allows for partial reservation on routers 110. RSVP generally does not support partial reservation so that when the reservation request fails in one router 110, the router 110 simply sends back a fail notification and flags the data flow as “blockade state”. The reservations already made at the downstream routers 110 are collected later when the soft states expire. In order to calculate the optimal reservation distribution among peer data flows, all of the bottlenecks among these data flows need to be found and available resource have to be reserved at the routers 110. By supporting partial reservation, the present invention allows the reservation request to go upstream even if it fails in the local admission control step. In this way, the necessary information can be collected and at the same time, the updating procedure speeds up because reservation has been made on more upstream routers 110.

The present invention also provides multiple reservations choices. RSVP only supports one TSPEC in the reservation step and requires the receiver terminal 114 to adjust reservation requests upon receiving the fail message. In order to decrease the updating time, the present invention is capable of providing multiple TSPECs in the reservation request message so that the routers 110 can make the largest possible reservation based on current load. When this happens, an error or failure message is produced including reserved sources and peer flow information, if any, and sent to the receiver terminal 114. In order to decrease the waste of resources on the routers I 10, the intermediate routers 110 can use a short timer to collect un-refreshed states. In the preferred embodiment, the confirmation message produced by the reservation end points (either the sender or merge point) for such intermediate routers 110 is used to learn the status of the reservation.

An updating phase of the reservation on respective routers 110 is also provided by the present invention. Because partial reservation is supported and aggressive reservation is made in the routers 110, an updating phase of reservation is needed. When all of the reservation requests succeed, the update phase is omitted and the present protocol behaves the same as RSVP. When a failure or error occurs, the updating of reservations must be accomplished and is set forth in greater detail below. After a data flows optimal distribution is calculated, the related distribution is sent out in the message of the updating phase. If some peer flows share the same bottleneck, the reserved resource will be redistributed among these flows and the success of this step is guaranteed because the resource is already available.

As set forth above, the present invention also provides the receiver terminal 114 with a dynamic resource reservation adjustment algorithm. The present protocol inputs related information to the dynamic resource reservation adjustment algorithm and utilizes the output from it to achieve the optimal resource reservation at respective routers 110. This allows the resources that are reserved at each respective router 110 to be dynamically adjusted as bottlenecks occur at respective routers 110 along the data path.

Another embodiment of the present invention provides modified join and leave procedures for data flows from the routers 110. When a data flow joins or leaves the application session 200 or terminal session 201, the treatment is not the same as in RSVP because the session here is not a multicast tree. If a data flow wants to join the application session 200, the data flow makes the reservation request individually to the routers 110. If the reservation request succeeds, the reservations of other data flows are not influenced. If the reservation fails, the receiver terminal 114 uses the feedback message provided by the respective router 110 to recalculate the optimal distribution and sends out an update message to those data flows influenced. In this way, the interruption of services is decreased to the lowest extent.

When a data flow leaves the terminal session 201, its reservation will be given back to the router 110. Because the receiver terminal 114 has no knowledge of the overall picture of data flow topologies except the bottleneck, the resource can't be claimed by its peer flows in the same application session 200. This may expose a problem because flows in the algorithm are willing to contribute their own reservation to their peers to get better performance. They cannot claim the resource back once their peers leave the application session 200. So the long life data flows tend to see their reservation continuously decreasing.

To partially solve the problem, once the tear down message is received by the intermediate router 110 and the corresponding resource is released by this data flow, the resource is not immediately been given back to the router 110 to reassign yet if there are other data flows of the same application session 200 going through this router 110. But it is reserved for some interval and reserved for the application session 200 so that if later some data flow joins the application session 200, it can claim this resource back and decrease the possibility of having to request bandwidth from its peers. The reservation bank is a soft-state and will be collected by the router 110 if it is not used by the application session 200 in some predefined interval. This treatment can be further motivated by the argument that when flows experience changes due to the mobility, if the mobility is local, the new path and old path could share some common link so that the resource bank of the application session 200 could give the new data flow larger probability to succeed.

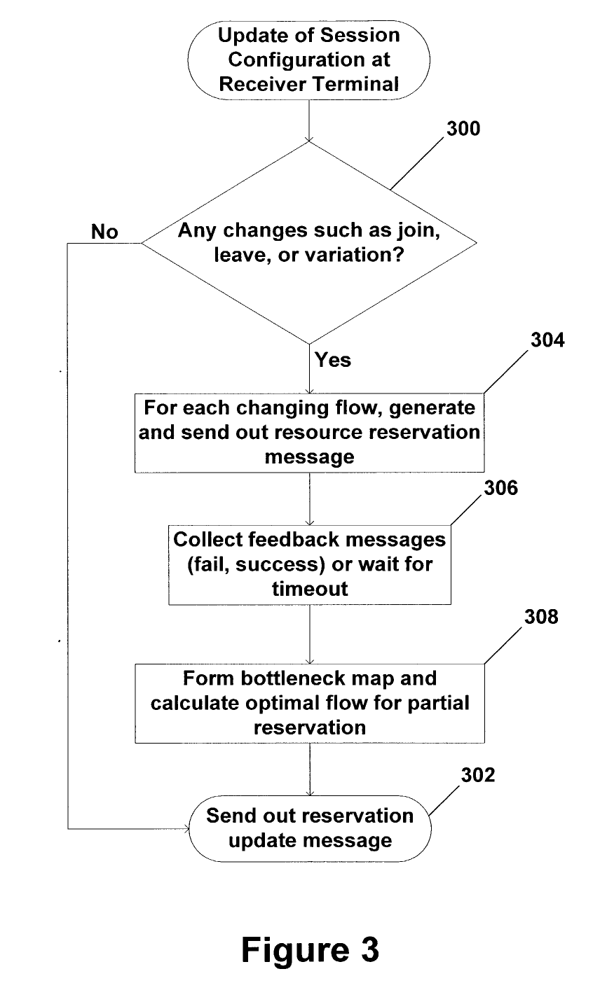

Referring to FIG. 3, a flow chart illustrating the steps that are taken by the receiver terminal 114 to update the configuration of the data flows for the application session 200 is set forth. At step 300, the receiver terminal 114 determines there have been any changes such as a data flow leaving, a data flow joining or a variation of a data flow. If there are no changes, a reservation update message is generated and sent out to the routers 110 that does not make any changes in the reservation at each respective router 110, which is illustrated at step 302.

If there is a change in a data flow, at step 304 for each changing data flow the receiver terminal 114 generates a new reservation message that is sent upstream to each respective router 110. At step 306, the receiver terminal 114 collects all feedback messages that are generated by the routers 110 along the data path. The feedback messages will indicate whether the reservation request failed, succeeded, or simply timed out at each respective router 110. The feedback messages preferentially also contain information about bottlenecks at respective routers 110 along the data path of a resource reservation message fails. At step 308, the receiver terminal 114 uses the information contained in the feedback messages from the routers 110 to determine where bottlenecks exist in the end-to-end data path. Using the dynamic resource reservation adjustment algorithm, the receiver terminal 114 calculates the optimal data flow reservations that need to be made at the routers 110 to satisfy the QoS needed by each data flow from the application session 200. Based on this calculation, at step 302 the receiver terminal 114 generates and transmits a resource reservation update message upstream to each router 110 that adjusts resource reservations in the routers 110 based on known bottlenecks in the end-to-end path.

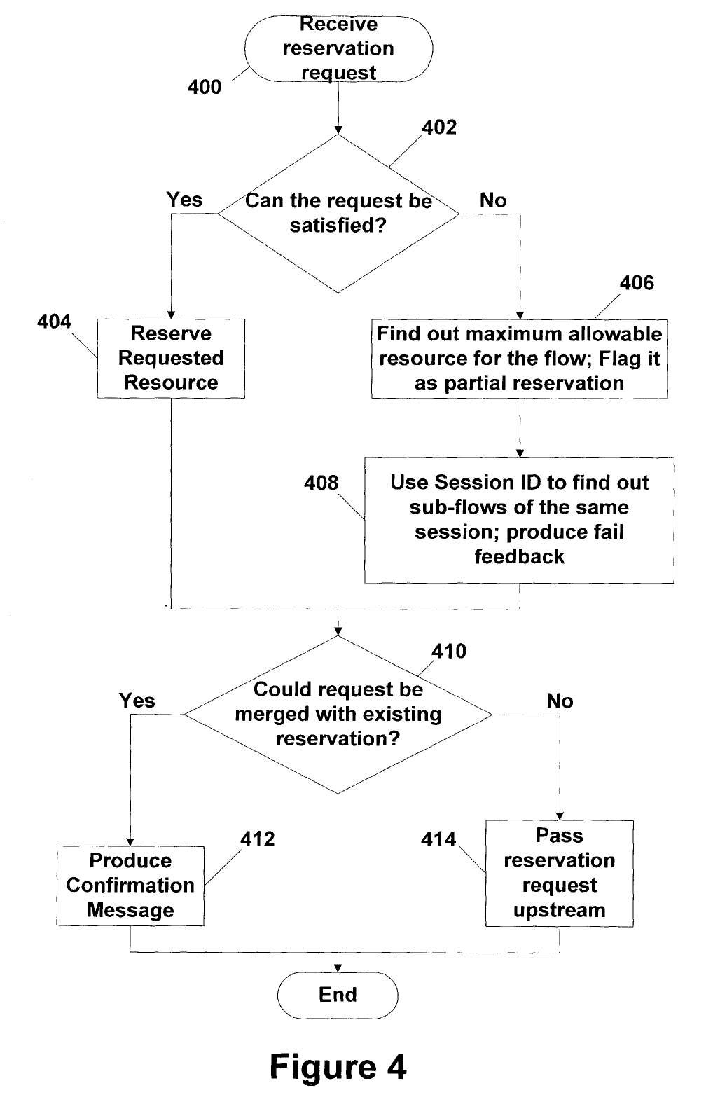

Referring to FIG. 4, a flow chart is illustrated that sets forth the process steps that are taken by the routers 110 once they receive a resource reservation request that is sent by the receiver terminal 114, which is illustrated at step 400. At step 402, the router 110 determines if the router 110 can satisfy the resource reservation request. If the router 110 can satisfy the resource reservation request, at step 404 the requested resource is reserved on the router 110. If the router 110 cannot satisfy the reservation request, at step 406 the router 110 determines the maximum allowable resource or bandwidth that is available for the data flow and flags the reservation request as a partial reservation. At step 408, the router 110 uses the session ID to find out sub-flows of the same terminal session 201 and produces a failure feedback message.

At step 410, the router 110 determines if the reservation request can be merged with an existing data flow reservation of the application session 200. If the reservation request can be merged with an existing reservation, at step 412 the router 110 generates a confirmation message that is sent to the receiver terminal 114. If the reservation request cannot be merged with an existing reservation, the router 110 passes the reservation request upstream to the next router 110, which is illustrated at step 414.

By combining the merits of existing protocols and cleverly tuning it to the present application scenario, the present invention provides an efficient and powerful signaling protocol. The present inventions provides low signaling overhead, optimal application performance, is optimal for wireless access networks, and requires minimal modifications to existing reservation protocols such as RSVP.

Traditional RSVP is one-pass if the reservation succeeded but experiences long delay if the reservation fails. The present invention uses an algorithm that is one-pass if the reservation succeeds but two-passes if the reservation fails. It can be further optimized to one-pass by piggybacking the update information with the first data packets.

When one or several sub-flows change during the terminal session 201, the reservation does not need to be repeated for each sub-flow, which decreases the overhead and also decreases the possibility of reservation failure of re-reservation of previously successful reservations. It also increases the successful chance of reservation of newly-added or newly-changing sub-flows.

The present invention is suitable for wireless access networks where the last wireless hop tends to be the bottleneck. It is also suitable for the local ISP networks where congestion is likely to happen and the scalability of signaling is not a big issue. The present invention also provides an interface between the admission control and the signaling protocol that has the enhancement of knowledge of bottleneck of resource reservations and competing peer flows at the bottleneck.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A network system, comprising:
a receiver terminal connected with at least one sender terminal by a plurality of hops, where:
the receiver terminal includes a flow configuration module that specifies the relative importance of at least one application session of a terminal session and a plurality of data flows of the application session;
the receiver terminal includes a resource reservation processing module operable to create a plurality of data flow reservations on the hops during a terminal session between the receiver terminal and the sender terminals;
the receiver terminal includes a partial resource reservation processing module operable to maintain a partial reservation on the hops; and
the receiver terminal includes a dynamic adjustment module having a dynamic adjustment algorithm operable to provide an optimal flow reservation distribution to compensate for a bottleneck experienced in a respective hop.

2. The network system of claim 1, where the hops include an extended resource reservation processing module which supports partial reservation and advanced reservation adjustment in the case of a data flow joining or leaving.

3. The network system of claim 1, where the data flow uses the partial reservation on the hops to reserve the most available resources for the terminal session.

4. The network system of claim 1, where the receiver terminal assigns a common session identification to the plurality of data flow reservations of the terminal session.

5. The network system of claim 1, where the hops include an admission control policy module operable to notify the receiver terminal when the bottleneck occurs in the respective hop and the composition of competing flows of the same session.

6. The network system of claim 1, where the receiver terminal uses an information message indicating a successful partial reservation to produce an optimal flow reservation distribution based on a user specified criteria and sends out a reservation update message.

7. A method of adjusting data flows in a data network, comprising the steps of:
reserving resources for a plurality of packet flows on a plurality of routers connected with a receiver terminal;
sending a feedback message from the routers to the receiver terminal indicating a bottleneck in a respective data flow;
determining an optimal packet flow reservation distribution based on a predetermined criteria with the receiver terminal; and
generating a resource reservation update message that is transmitted to the respective router with the bottleneck adjusting the packet flows at the respective router to compensate for the bottleneck.

8. The method of claim 7, where a dynamic adjustment algorithm is used to determine the adjustment that should be made to the packet flows.

9. The method of claim 7, where the feedback message includes a configuration indication of other packet flows from the same receiver terminal.

10. The method of claim 8, where the configuration indication of other packet flows is used to adjust the packet flows to compensate for the bottleneck.

11. The method of claim 7, where the predetermined criteria may be selected from a group of criteria including an application priority, a user preference and a current topology of the router having the bottleneck.

12. The method of claim 7, further comprising the step of creating a partial resource reservation on the routers to provide an additional data flow resource in the event a bottleneck occurs on a respective router.

13. The method of claim 7, further comprising the step of dynamically adjusting the resource distribution of competing flows in the bottleneck to achieve an optimal performance.

14. The method of claim 7, further comprising the step of treating the dynamic leaving or joining of a respective packet flow where the reserved resource of one leaving flow is not given back to the router immediately, where the router is instructed to wait for a short period of time to be reused by a new joining flow of the same session.

15. A packet-switching data network, comprising:
a receiver terminal connected with at least one sender terminal, where the receiver terminal is connected with each sender terminal by a plurality of routers, where the receiver terminal is operable to reserve a plurality of packet flows between the receiver terminal and the sender terminal for a terminal session, where the receiver terminal is operable to create a partial reservation for a packet flow between the receiver terminal and the sender terminal, where the routers are operable to generate a bottleneck indication that is sent to the receiver terminal if a respective packet flow cannot satisfy a predefined level of QoS, and where the receiver terminal includes a route optimization module with a dynamic resource reservation algorithm that recalculates an optimal resource distribution of the packet flows of the same terminal session to achieve an optimal level of performance.

16. A method of controlling data flows between a receiver terminal and a sender terminal in a data network, comprising the steps of:
reserving a plurality of data flow resources for a terminal session having a plurality of data flows at a plurality of routers connected with the receiver terminal and the sender terminal;
generating a feedback message with a respective router that is sent to the receiver terminal if a bottleneck occurs at the respective router; and
using a dynamic adjustment algorithm to adjust the packet flows at the routers to obtain an optimal flow reservation distribution.
